(19) United States
(12) Patent Application Publication
(10) Pub. No.: US 2017/0046470 A1
(43) Pub. Date: Feb. 16, 2017

(54) PROCESS DESIGN KIT FOR EFFICIENT AND ACCURATE MISMATCH SIMULATION OF ANALOG CIRCUITS

(71) Applicant: GLOBALFOUNDRIES Inc., George Town (KY)

(72) Inventors: Radhika ALLAMRAJU, Bangalore (IN); Santhosh MADHAVAN, Bangalore (IN); Umashankar MAHALINGAM, Bangalore (IN); Shrinivas J. PANDHARPURE, Bangalore (IN); Giri N. RANGAN, Bangalore (IN); Ashwin SRINIVAS, Bangalore (IN)

(21) Appl. No.: 14/826,250

(22) Filed: Aug. 14, 2015

(51) Int. Cl. G06F 17/50

(52) U.S. Cl. CPC G06F 17/5081; G06F 17/5009

(57) ABSTRACT

Approaches for a process design kit (PDK) for designing or manufacturing an integrated circuit with a hierarchical parameterized cell (PCELL) are provided. The PDK includes at least one model parameter which indicates a layout technique of the hierarchical PCELL, at least one hierarchical PCELL parameter which indicates at least one of the layout technique of the hierarchical PCELL and a parasitic characteristic of the hierarchical PCELL, and at least one layout vs. schematic (LVS) parameter which indicates the layout technique of the hierarchical PCELL. The hierarchical PCELL includes a pair of matching transistors. The PDK is configured to simulate and output mismatch characteristics and local variation characteristics of the hierarchical PCELL based on the at least one model parameter, the at least one hierarchical PCELL, and the at least one LVS parameter.

The invention relates to a process design kit (PDK) which provides quantitative information on layout-based mismatch statistics, and more particularly, to a PDK which provides designers the ability to analyze the issue of mismatch optimization or local variations in a schematic design phase of the development process while also considering the effect of the optimized design on parasitic characteristics.

### BACKGROUND

In analog circuit design, accurate prediction of mismatch or local variations is very important. In particular, with the advent of non-traditional device structures (e.g., non-planar) and advanced nodes, mismatch or local variations contribute to a major part of the overall variations.

Process Design Kits (PDK) do not account for mismatch and local variations extracted based on layout choice. Therefore, after the design at a schematic level in a known PDK system, layout designers attempt to solve context-aware problems such as mismatch or local variations in a layout design stage of the development process. For example, layout designers may apply smart layout technologies to reduce the mismatch or local variation effects.

However, as the true mismatch or local variations effects are not known at the schematic design level, the layout designers need to apply the smart layout technologies in a non-quantitative manner. In response to mismatch and local variations not being known at the schematic design level, a schematic designer may overdesign the analog circuit which may result in longer design turnaround time (TAT), a larger silicon area, and higher power consumption.

### SUMMARY

In a first aspect of the invention, there is a process design kit (PDK) for designing or manufacturing an integrated circuit with a hierarchical parameterized cell (PCELL) which includes at least one model parameter which indicates a layout technique of the hierarchical PCELL, at least one hierarchical PCELL parameter which indicates at least one of the layout technique of the hierarchical PCELL and a parasitic characteristic of the hierarchical PCELL, and at least one layout vs. schematic (LVS) parameter which indicates the layout technique of the hierarchical PCELL. The hierarchical PCELL includes a pair of matching transistors. The PDK is configured to simulate and output mismatch characteristics and local variation characteristics of the hierarchical PCELL based on the at least one model parameter, the at least one hierarchical PCELL, and the at least one LVS parameter.

In another aspect of the invention, there is a method for simulating an integrated circuit with a hierarchical parameterized cell (PCELL) which includes configuring at least one model parameter which indicates a layout technique of the hierarchical PCELL, at least one hierarchical PCELL parameter which indicates at least one of the layout technique of the hierarchical PCELL and a parasitic characteristic of the hierarchical PCELL, and at least one layout vs. schematic (LVS) parameter which indicates the layout technique of the hierarchical PCELL, and simulating and outputting mismatch and local variations of the hierarchical PCELL in order to optimize layout design at a schematic level based on the configured at least one model parameter and the configured at least one hierarchical PCELL parameter. The hierarchical PCELL includes a pair of matching transistors.

In yet another aspect of the invention, there is a method for simulating an integrated circuit with a hierarchical parameterized cell (PCELL) which includes configuring a layout technique at a schematic level in order to define at least one model parameter which indicates the layout technique of the hierarchical PCELL, at least one hierarchical PCELL parameter which indicates the layout technique of the hierarchical PCELL, and at least one layout vs. schematic (LVS) parameter which indicates the layout technique of the hierarchical PCELL, and simulating and outputting mismatch and local variations of the hierarchical PCELL in order to optimize layout design at the schematic level based on the configured layout technique. The hierarchical PCELL includes a pair of matching transistors.

### BRIEF DESCRIPTION OF THE DRAWINGS

FIG. 1 shows a schematic view of transistor layout structures.

FIG. 2 shows a schematic view of a process design kit (PDK) in accordance with aspects of the invention.

FIG. 3 shows a flow diagram of a method in accordance with aspects of the invention.

FIG. 4 shows a schematic view of a component description format (CDF) snapshot of a hierarchical parametric cell (PCELL) in accordance with aspects of the invention.

FIG. 5 shows a schematic view of a Layout vs. Schematic (LVS) interface in accordance with aspects of the invention.

FIG. 6 shows a graphical view of the results of the process design kit (PDK) of FIG. 2 in accordance with aspects of the invention.

FIG. 7 shows a high level architecture for implementing processes in accordance with aspects of the invention.

### DETAILED DESCRIPTION

The invention relates to a process design kit (PDK) which provides quantitative information on layout-based mismatch statistics, and more particularly, to a PDK which provides designers the ability to analyze the issue of mismatch optimization or local variations in a schematic design phase of the development process while also considering the effect of the optimized design on parasitic characteristics. Advantageously, the systems and methods provide analog designers an advantage of optimizing their designs from a composite view of mismatch and parasitic characteristics early in a design lifecycle, leading to shorter turnaround time (TAT) and more efficient design choices. In other words, the present invention provides a PDK with a priori quantitative information on layout-based mismatch statistics at the schematic level.

In embodiments, the PDK in accordance with aspects of the invention addresses several shortcomings in known systems and methods. For example, the PDK includes schematic (e.g., pre-layout) simulation which is sensitive to an intended layout of a designer for mismatch improvement while considering parasitic contribution. Further, in another example, the PDK includes coding to skew the mismatch parameters and add parasitic components based on intended layout choice at a schematic level simulation. In another example, the PDK allows for hierarchical parametric cell (PCELL) based extreme corner models. In another example, the PDK includes schematic (e.g., pre-layout) simulation for any kind of layout for mismatch improvement.

In yet another example, parameterized cells (PCELLs) of the embodiments are hierarchical with different wiring options provided to achieve an intended optimized design. In embodiments of the present invention, providing symbols linked to hierarchical PCELLs at a schematic level enhances discoverability when shipped in the PDK. Further, embodiments of the present invention allow for physical verification runsets to extract the appropriate mismatch context without post-processing the layout. Lastly, device models in the embodiments can have appropriate scaling for mismatch contexts.

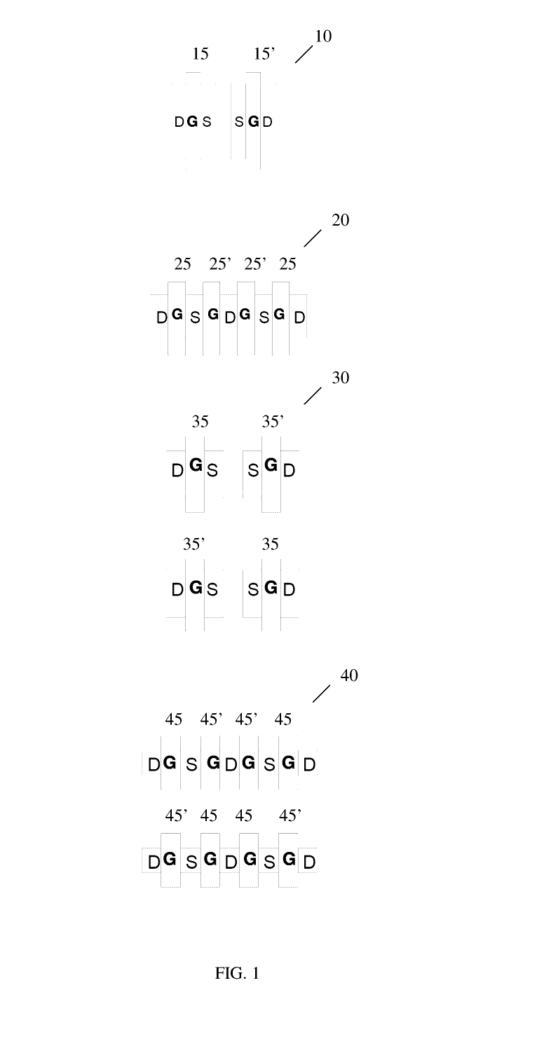

FIG. 1 shows a schematic view of transistor layout structures. In particular, FIG. 1 shows a simple layout 10, an interdigitated layout 20, a common centroid layout 30, and a common centroid with interdigitated layout 40. As shown in FIG. 1, each transistor (e.g., analog transistor) is shown with a gate (e.g., “G”), drain (e.g., “D”), and a source (e.g., “S”). In the simple layout 10 shown in FIG. 1, a differential pair of transistors 15 and 15′ are shown. In the simple layout 10, there may be local variations and mismatches between the differential pair of transistors 15 and 15′. Therefore, a designer in a layout design stage of the development process may apply a smart layout technique in order to reduce the local variation effects and mismatches between the differential pair of transistors 15 and 15′. Further, these smart layout techniques primarily address systematic mismatches in circuit elements. However, the smart layout techniques described herein also tend to tighten the statistics of the random variations.

In one example of a smart layout shown in FIG. 1, the designer in the layout design stage of the development may use an interdigitated layout 20 in order to reduce the local variation effects and mismatches between a differential pair of transistors 25 and 25′. As shown in FIG. 1, transistor 25 is placed on both ends of the interdigitated layout 20 while two transistors 25′ are sandwiched between the transistors 25 on both ends of the interdigitated layout 20. Further, a source (e.g., “S”) is shared between transistor 25 and 25′ and a drain (e.g., “D”) is shared between two transistors 25′. Thus, the interdigitated layout 20 helps to reduce the local variation effects and mismatches between the differential pair of transistors 25 and 25′. In another example of a smart layout shown in FIG. 1, the designer in the layout design may use a common centroid layout 30 in order to reduce the local variation effects and mismatches between a differential pair of transistors 35 and 35′. As shown in FIG. 1, a transistor 35 and 35′ in a top row of the common centroid layout 30 are placed in a similar configuration to the simple layout 10 (i.e., transistor 35 is placed to the left of the transistor 35′). However, in the bottom row, the layout of the transistor 35 and 35′ are flipped such that the transistor 35′ is placed to the left of the transistor 35. In the common centroid layout 30, local variation effects and mismatches between the differential pair of transistors 35 and 35′ are reduced.

In yet another example of a smart layout shown in FIG. 1, the designer in the layout design stage of the development may use a common centroid with interdigitated layout 40. The common centroid with interdigitated layout 40 includes a differential pair of transistors 45 and 45′. Further, the common centroid with interdigitated layout 40 combines the features of the interdigitated layout 20 and the common centroid layout 30 in order to reduce the local variation effects and mismatches between the differential pair of transistors 45 and 45′.

In an example, the simple layout 10 uses a simple differential pair in which matching circuits are kept side by side. This ensures a very simple design with less parasitic characteristics, but more mismatch between the matching circuits. Alternatively, when using the common centroid layout 30, there is not much mismatch between the matching circuits, but parasitic characteristics may be increased. Therefore, the layout designer must apply different layout techniques in order to address the tradeoff between parasitic characteristics and mismatch.

However, embodiments are not limited to the transistor layout structures shown in FIG. 1. For example, a designer in a layout design may use a different transistor layout structure to reduce local variation effects and mismatches. Further, although a differential pair of field effect transistors (e.g., MOSFET devices) are shown, any other type of matching transistor pair (e.g., bipolar transistor) or matching electrical circuit pair may be used (e.g., offset correction digital-to-analog converters, duty cycle correction digital-to-analog converters, etc.)

In known systems and methods, layout structures are performed by a designer in a layout design stage of the development process. However, known systems and methods do not allow for layout optimization at a schematic level in order to reduce the local variations and mismatches. In fact, known systems and methods of PDK do not include local variation and mismatch information, which leads to a non-quantitative decision on the mismatch and parasitic characteristics in the layout design stage of the development process. Further, without the local variation and mismatch information in the PDK, a schematic designer may overdesign which can result in longer design turnaround time (TAT), increased silicon area, and higher power consumption.

In simulations, an output offset voltage may be measured for a simple differential amplifier. Between schematic and extracted netlists, a mean is slightly shifted. However, a is more or less the same. Therefore, layout circuit designers use different layout techniques for a matched pair of transistors (e.g., analog transistors) to reduce mismatch. Further, layout circuit designers must navigate the tradeoff between tolerable mismatch and circuit parasitic when applying the different layout techniques.

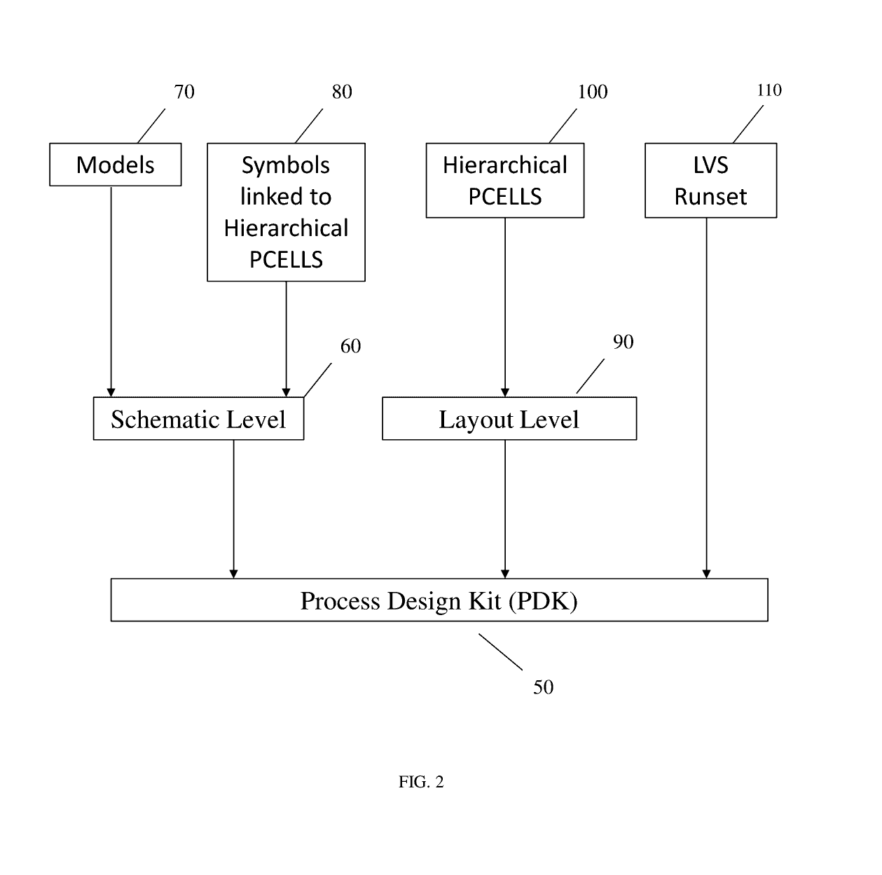

FIG. 2 shows a view of a process design kit (PDK) 50 in accordance with aspects of the invention. In FIG. 2, a schematic level 60 of the embodiments may include new models 70 and new symbols linked to hierarchical PCELLS 80. In FIG. 2, a layout level 90 of the embodiments may include new hierarchical PCELLS 100. In FIG. 2, the PDK 50 will contain a new set of parameters indicating a layout choice within the LVS runset level 110. In the models 70 at the schematic level 60, new model instance parameters will be included which indicate a layout choice (e.g., interdigitated, common centroid, a combination of both interdigitated and common centroid, etc.) For example, a model instance parameter may be defined as below:

<model_param_name>=<value>,

wherein value=1 (interdigitated), 2 (common centroid), . . .

The hierarchical PCELLS 100 allow for a matched device pair which includes layout and parasitic choices. For example, the hierarchical PCELLS 100 may include a MOSFET device selection, a layout choice (interdigitated, common centroid, . . . ), and estimated parasitic characteristics (e.g., R+C) which is set to be on or off. Therefore, in the schematic level 60, a schematic netlist with instance parameters based on the device, layout, and parasitic choices may be generated and used. The Layout vs. Schematic (LVS) Runset 110 includes new LVS switches which are added to a LVS form and which indicate layout choice without the necessity to post-process the layout.

The schematic level 60 and the layout level 90 of the PDK 50 may also include the features in known systems and methods. However, in the embodiments, the schematic level of the PDK 50 includes new models 70, new symbols linked to hierarchical PCELLs 80. Further, the layout level 90 of the PDK 50 includes new hierarchical parameterized cells (PCELLS) 100. The PDK level 50 also includes a new LVS runset 110, which is not part of known systems and methods. Therefore, in embodiments, local variations and mismatch characteristics can be incorporated at the PDK 50 (i.e., at a schematic level). Further, in contrast to known systems and methods, no layout post processing is required.

In the embodiments, at the schematic level 60 of the PDK 50, hierarchical symbols for a matched device pair can be generated. Further, at the schematic level 60 of the PDK 50, device models with appropriate mismatch scaling can be used. At the schematic level 60 of the PDK 50, symbols linked to hierarchical PCELLS 80 for matched device pair may include a layout technique and parasitic choices. Further, at the schematic level 60 of the PDK 50, layout-aware device models may be generated. At the layout level 90 of the PDK 50, hierarchical PCELLS 100 for a matched device pair can be generated. At the layout level 90 the hierarchical PCELLS for a matched device pair include layout and parasitic choices. At the PDK 50, a new LVS runset 110 with switches for the appropriate layout choice can be selected.

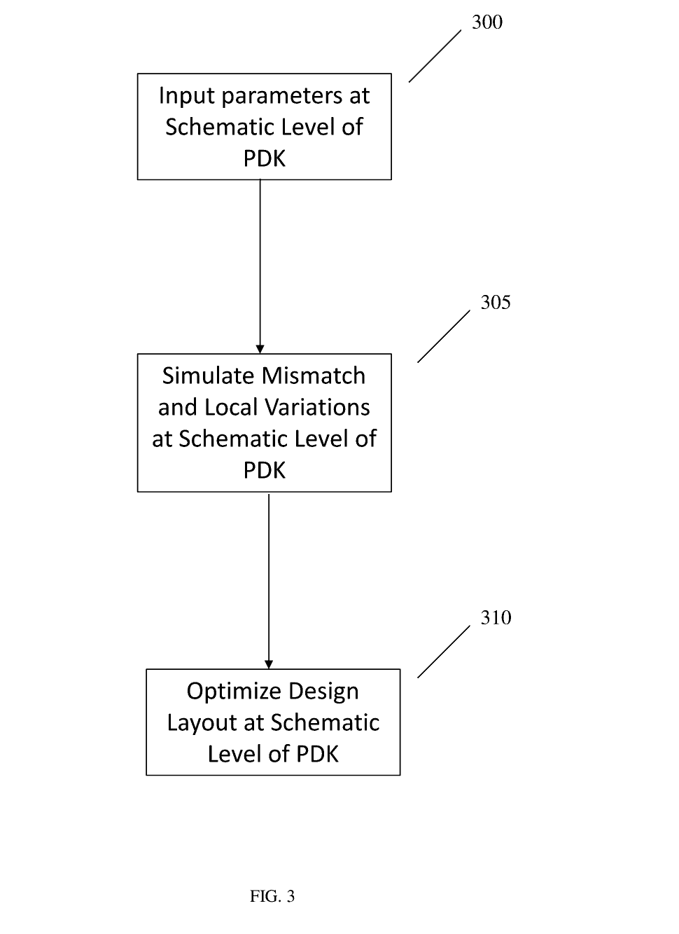

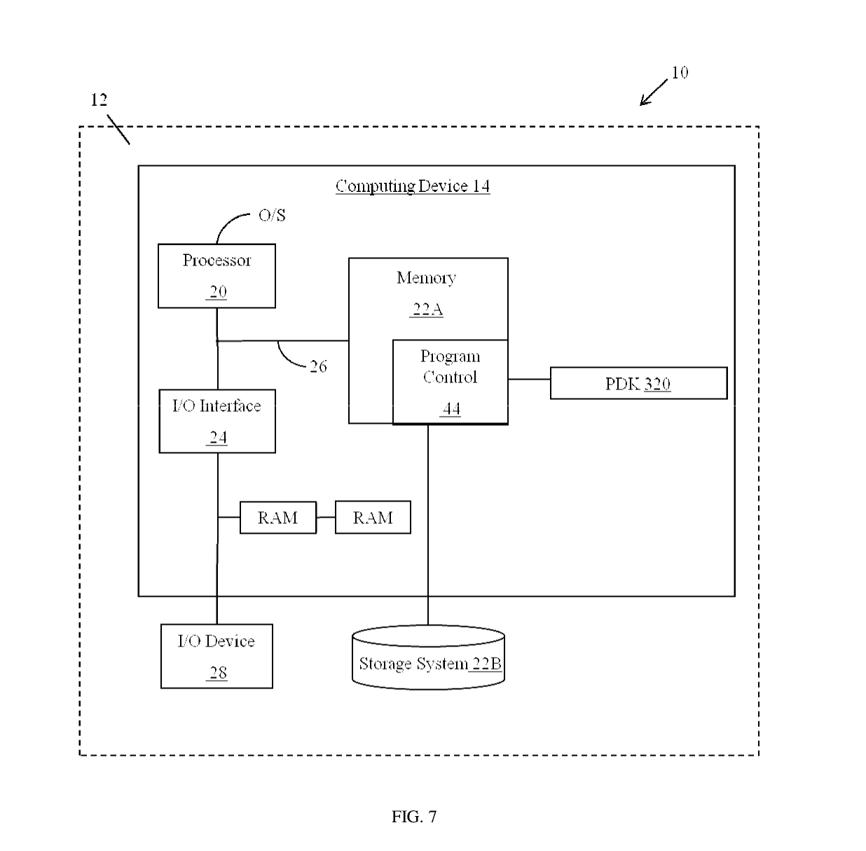

FIG. 3 shows a flow diagram of a method in accordance with aspects of the invention. In particular, FIG. 3 may be implemented on the structures shown in FIG. 7. The flow diagram illustrates the architecture, functionality, and operation of possible implementations of systems, methods, and computer program products as described herein in accordance with various embodiments of the present invention.

FIG. 3 shows a flow diagram of a method in accordance with aspects of the invention. A process design kit (PDK) may include an intellectual property (IP) library. The IP library may include process models and design kits in appropriate technology file formats for use by circuit designers. The PDK is used to perform various simulations of hardware integrated circuits (ICs) for manufacturing of the hardware ICs. PDKs may include geometric descriptions and models of devices, such as transistors (e.g., analog transistors), diodes, resistors, capacitors, etc. Designers may translate PDKs to transistor netlists and/or gate-level netlists for circuit simulation. Based on the simulation results, design engineers can predict and/or modify the IC design in order to optimize the design layout for particular characteristics (e.g., parasitic characteristics, mismatch characteristics, local variations, etc.).

In FIG. 3, at step 300, parameters may be input at a schematic level of a process design kit (PDK). For example, at the schematic level of the PDK, model parameters (e.g., parameters from new models 70 in FIG. 2), hierarchical PCELL parameters from the linked symbols (e.g., parameters from new symbols linked to hierarchical PCELLS 80) will be input at the schematic level of the PDK.

Further, at step 300, at least one model parameter may indicate a layout technique of the hierarchical PCELL. Also, at least one hierarchical PCELL parameter from the symbol may indicate at least one of the layout technique of the hierarchical PCELL and a parasitic characteristic of the hierarchical PCELL. Other parameters may be included in the PDK for running the simulation.

At step 305, a simulation is run with the PDK in order to simulate and output at least one of mismatch characteristics, local variations, parasitic characteristics, etc., based on the at least one model parameter and the at least one hierarchical PCELL parameter from the linked symbol. The simulation of the PDK is done at the schematic level. The mismatch characteristics, local variations, and parasitic characteristics can then be used by designers to quantitatively analyze the analog designs for optimization.

At step 310, a designer may optimize a design layout at the schematic level of the PDK. For example, the designer may observe the mismatch characteristics, local variations, and parasitic characteristics of the last simulation, and change a layout of the analog designs, change parameters, and/or change specific hardware ICs (e.g., analog transistors) used, etc., in order to optimize the design layout at the schematic level of the PDK. In an exemplary embodiment, the layout design may be optimized by minimizing both the mismatch and parasitic characteristics of the hierarchical PCELLs.

One of ordinary skill in the art would understand that mismatch and parasitic characteristics have an inverse relationship (i.e., there is a tradeoff between the mismatch and parasitic characteristics), so the minimization would have to use a tolerable mismatch and tolerable parasitic characteristic (instead of an absolute minimum of either value or both values). In embodiments, a designer can effectuate these changes at a schematic level of the PDK, instead of at a layout level in known systems and methods.

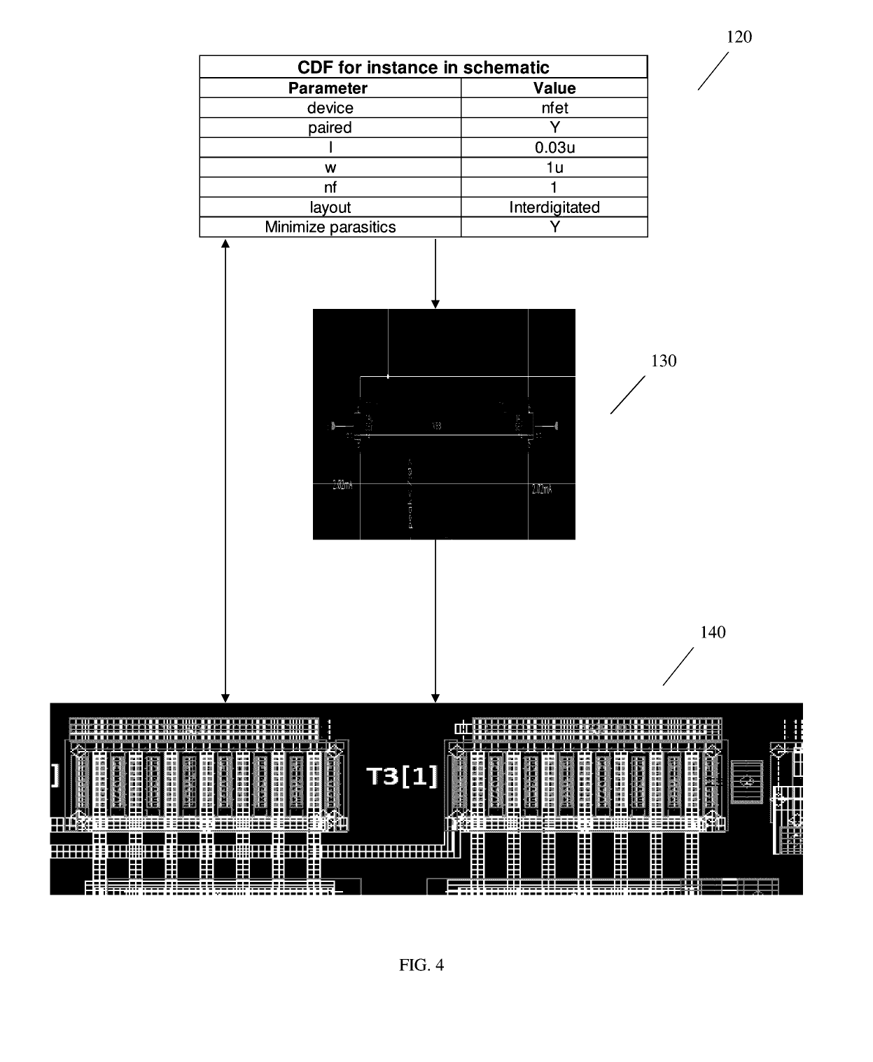

FIG. 4 shows a schematic view of a component description format (CDF) snapshot of a hierarchical parametric cell (PCELL) in accordance with aspects of the invention. In FIG. 4, a component description format 120 allows a user to select a desired device, layout, and parasitic choice. Therefore, using the component description format 120, a schematic 130 of the desired device can be generated. A hierarchical PCELL 140 for a paired device would take a same parameter as the schematic instance.

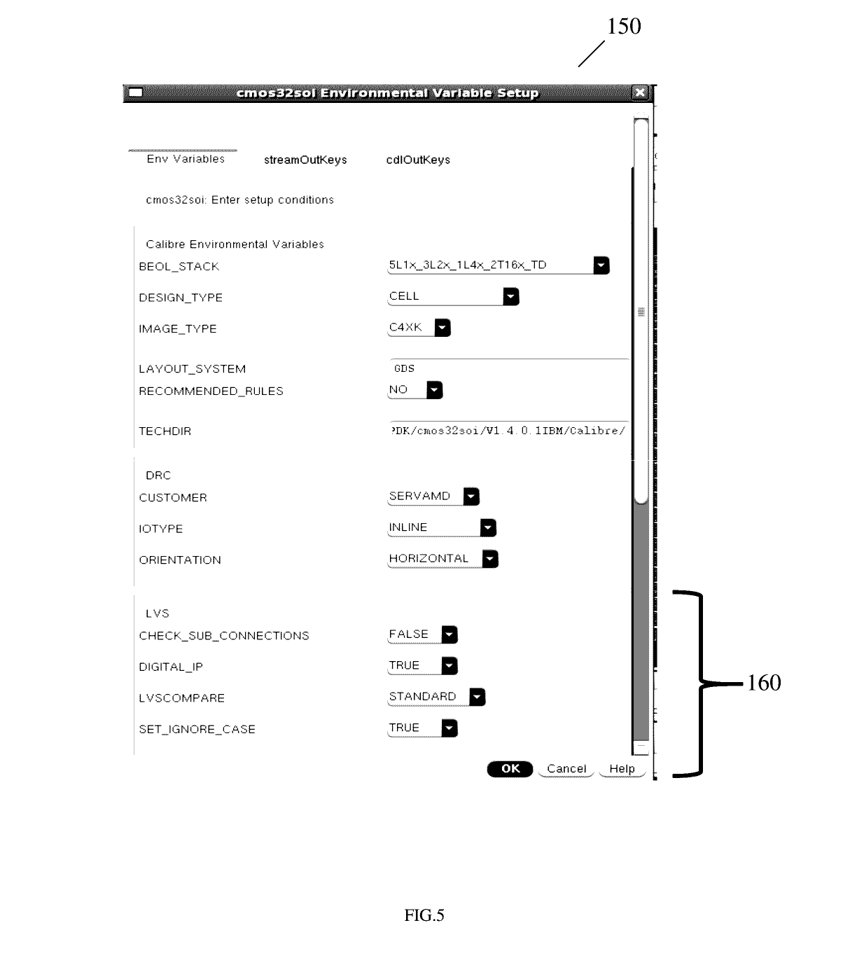

FIG. 5 shows a schematic view of a Layout vs. Schematic (LVS) interface in accordance with aspects of the invention. In FIG. 5, an environmental variable setup screen 150 is used to define parameters for the LVS runset. In FIG. 4, new LVS switches 160 (e.g., LVS switch parameters) are added to indicate layout aware mismatch parameters which can be selected. The LVS switch parameter may be added to a LVS netlist at the PDK level while generating a post-layout extracted netlist. The added switch provides the option of indicating the appropriate layout choice for the matched pair of devices as selected in the schematic level without the need to post-process the layout. For example, a LVS switch parameter may be defined as below:

<LVS_param_name>=<value>,

wherein value=1 (interdigitated), 2 (common centroid) . . .

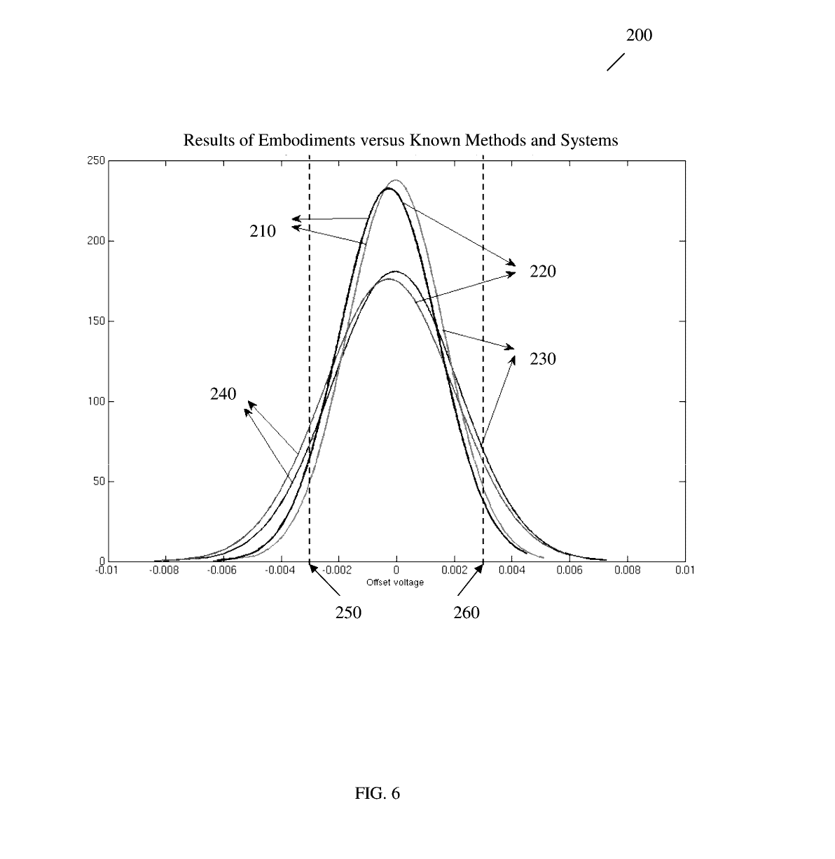

FIG. 6 shows a graphical view of the results of the process design kit (PDK) of FIG. 2 in accordance with aspects of the invention. For example, the graphical view 200 of the results of the PDK can be generated directly from the PDK or can be generated using a separate program (i.e., graphing software) which use the outputs of a simulation performed in the PDK. In FIG. 6, an offset voltage is plotted on the X-axis and a number of measurements of the offset voltage (out of 1,000 measurements) is plotted on the Y-axis for a simple differential amplifier. FIG. 6 shows a graph (i.e., probability distribution curve) of the models in accordance with the embodiments 210 and a graph of the known method and system models 240. Further, in FIG. 6, the graph includes a mismatch with an extracted netlist 220 and a mismatch with schematic only netlist 230. In FIG. 6, the lower bounds 250 and upper bounds 260 are shown at specified offset voltages.

In FIG. 6, the graph of the models in accordance with the embodiments 210 improved mismatching by about 25% in comparison to the graph of the known method and system models 240. The graph of the models in accordance with the embodiments 210 is based on an optimized layout which corrects for mismatch and local variation information at the schematic level. Although the graph of the models in accordance with the embodiments 210 is simulated for a simple differential amplifier, testing and simulations may be run to optimize other circuitry, such as offset correction DACs, DCC correction DACs, etc., in order to reduce mismatch and local variations.

FIG. 7 shows a high level architecture for implementing processes in accordance with aspects of the invention. In particular, FIG. 7 shows an illustrative environment 10 for managing the processes in accordance with the invention. To this extent, environment 10 includes a server 12 or other computing system that can perform the processes described herein. In particular, server 12 includes a computing device 14. The computing device 14 can be resident on a network infrastructure or computing device of a third party service provider (any of which is generally represented in FIG. 7).

The computing device 14 also includes a processor 20 (e.g., CPU), memory 22A, an I/O interface 24, and a bus 26. The memory 22A can include local memory employed during actual execution of program code, bulk storage, and cache memories which provide temporary storage of at least some program code in order to reduce the number of times code must be retrieved from bulk storage during execution. In addition, the computing device includes random access memory (RAM), a read-only memory (ROM), and an operating system (O/S).

The computing device 14 is in communication with external I/O device/resource 28 and storage system 22B. For example, I/O device 28 can comprise any device that enables an individual to interact with computing device 14 (e.g., user interface) or any device that enables computing device 14 to communicate with one or more other computing devices using any type of communications link. The external I/O device/resource 28 may be for example, a handheld device, PDA, handset, keyboard etc.

In general, processor 20 executes computer program code (e.g., program control 44), which can be stored in memory 22A and/or storage system 22B. Moreover, in accordance with aspects of the invention, program control 44 controls a PDK 320, which performs the processes described herein. The PDK 320 can be implemented as one or more program code in program control 44 stored in memory 22A as separate or combined modules. Additionally, the PDK 320 may be implemented in a programmable gate array, as separate dedicated processors, or a single or several processors to provide the function of these tools. While executing the computer program code, the processor 20 can read and/or write data to/from memory 22A, storage system 22B, and/or I/O interface 24. The program code executes the processes of the invention. The bus 26 provides a communications link between each of the components in computing device 14.

By way of example, the PDK 320 may be configured to take input parameters (e.g., model parameters and hierarchical PCELL parameters via the linked symbol) at a schematic level, simulate a mismatch, local variations, and parasitic characteristics of a analog design circuit using the input parameters at the schematic level, and optimize a design layout based on the results of the mismatch, local variations, and parasitic characteristics from the simulation at the schematic level. Optimizing at the design level may include changing a layout of the analog designs, changing parameters, and/or changing specific analog designs used, etc. Further, the PDK 320 may use any commercially available or proprietary software available to one of ordinary skill in the art in order to accomplish the simulation (e.g., HSPICE, SPECTRE, etc.).

The computing device 14 can comprise any general purpose computing article of manufacture capable of executing computer program code installed thereon (e.g., a personal computer, server, etc.). However, it is understood that computing device 14 is only representative of various possible equivalent-computing devices that may perform the processes described herein. To this extent, in embodiments, the functionality provided by computing device 14 can be implemented by a computing article of manufacture that includes any combination of general and/or specific purpose hardware and/or computer program code. In each embodiment, the program code and hardware can be created using standard programming and engineering techniques, respectively.

Similarly, server 12 is only illustrative of various types of computer infrastructures for implementing the invention. For example, in embodiments, server 12 comprises two or more computing devices (e.g., a server cluster) that communicate over any type of communications link, such as a network, a shared memory, or the like, to perform the process described herein. Further, while performing the processes described herein, one or more computing devices on server 12 can communicate with one or more other computing devices external to server 12 using any type of communications link. The communications link can comprise any combination of wired and/or wireless links; any combination of one or more types of networks (e.g., the Internet, a wide area network, a local area network, a virtual private network, etc.); and/or utilize any combination of transmission techniques and protocols.

In another embodiment, a PDK can run simulations of hierarchical PCELL-based extreme corner models. Extreme corner models are simulations which are run at extreme cases of Monte Carlo simulations. Although extreme corner model simulations are previously known for a single device, a PDK of the embodiments can utilize information from hierarchical PCELLs to generate a simulation of hierarchical PCELL-based extreme corner models for hierarchical PCELL devices.

The method(s) as described above is used in the fabrication (i.e., manufacturing) and simulation of integrated circuit chips. The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A process design kit (PDK) for designing or manufacturing an integrated circuit with a hierarchical parameterized cell (PCELL), the PDK comprising:
at least one model parameter which indicates a layout technique of the hierarchical PCELL;
at least one hierarchical PCELL parameter which indicates at least one of the layout technique of the hierarchical PCELL and a parasitic characteristic of the hierarchical PCELL; and
at least one layout vs. schematic (LVS) parameter which indicates the layout technique of the hierarchical PCELL,
wherein the hierarchical PCELL comprises a pair of matching transistors, and
wherein the PDK is configured to simulate and output mismatch characteristics and local variation characteristics of the hierarchical PCELL based on the at least one model parameter, the at least one hierarchical PCELL, and the at least one LVS parameter.

2. The PDK of claim 1, wherein the at least one model parameter and the at least one hierarchical PCELL are configured at a schematic level, and the hierarchical PCELL is configured via linked symbols.

3. The PDK of claim 1, wherein the layout technique comprises one of a simple layout technique, an interdigitated layout technique, a common centroid layout technique, and a combination of a common centroid with interdigitated layout technique.

4. The PDK of claim 1, wherein the PDK is configured to simulate and output mismatch and local variations of the hierarchical PCELL in order to optimize layout design at a schematic level.

5. The PDK of claim 4, wherein the layout design is optimized by minimizing both the mismatch and parasitic contributions of the hierarchical PCELL.

6. The PDK of claim 1, wherein the pair of matching transistors comprise a pair of MOSFET devices.

7. The PDK of claim 1, wherein the pair of matching transistors comprise a correction circuitry.

8. The PDK of claim 1, wherein the PDK is configured to simulate extreme corner models for the hierarchical PCELL.

9. A method for simulating an integrated circuit with a hierarchical parameterized cell (PCELL), the method comprising:
configuring at least one model parameter which indicates a layout technique of the hierarchical PCELL, at least one hierarchical PCELL parameter which indicates at least one of the layout technique of the hierarchical PCELL and a parasitic characteristic of the hierarchical PCELL, and at least one layout vs. schematic (LVS) parameter which indicates the layout technique of the hierarchical PCELL; and
simulating and outputting mismatch and local variations of the hierarchical PCELL in order to optimize layout design at a schematic level based on the configured at least one model parameter and the configured at least one hierarchical PCELL parameter,
wherein the hierarchical PCELL comprises a pair of matching transistors.

10. The method of claim 9, further comprising simulating extreme corner models for the hierarchical PCELL.

11. The method of claim 9, wherein the at least one model parameter, the at least one hierarchical PCELL, and the at least one LVS parameter are defined at the schematic level.

12. The method of claim 9, wherein the layout technique comprises one of a simple layout technique, an interdigitated layout technique, a common centroid layout technique, and a combination of a common centroid with interdigitated layout technique.

13. The method of claim 9, wherein the layout design is optimized by minimizing both the mismatch and parasitic contributions of the hierarchical PCELL.

14. The method of claim 9, wherein the pair of matching transistors comprise a pair of MOSFET devices.

15. The method of claim 9, wherein the pair of matching transistors comprise a correction circuitry.

16. A method for simulating an integrated circuit with a hierarchical parameterized cell (PCELL), the method comprising:
configuring a layout technique at a schematic level in order to define at least one model parameter which indicates the layout technique of the hierarchical PCELL, at least one hierarchical PCELL parameter which indicates the layout technique of the hierarchical PCELL, and at least one layout vs. schematic (LVS) parameter which indicates the layout technique of the hierarchical PCELL; and
simulating and outputting mismatch and local variations of the hierarchical PCELL in order to optimize layout design at the schematic level based on the configured layout technique,
wherein the hierarchical PCELL comprises a pair of transistors.

17. The method of claim 16, wherein the layout technique comprises one of a simple layout technique, an interdigitated layout technique, a common centroid layout technique, and a combination of a common centroid with interdigitated layout technique.

18. The method of claim 16, wherein the layout design is optimized by minimizing both the mismatch and parasitic contributions of the hierarchical PCELL.

19. The method of claim 16, further comprising simulating extreme corner models for the hierarchical PCELL.

20. The method of claim 16, wherein the pair of transistors comprise a pair of MOSFET devices.
